(19) United States
(12) Patent Application Publication
(10) Pub. No.: US 2020/0319223 A1
(43) Pub. Date: Oct. 8, 2020

(54) SENSOR COMPONENT

(71) Applicant: Sumitomo Wiring Systems, Ltd., Yokkaichi-shi, Mie (JP)

(72) Inventors: Masaharu NAKAMURA, Yokkaichi-shi, Mie (JP); Kyungwoo KIM, Yokkaichi-shi, Mie (JP); Toshinari KOBAYASHI, Yokkaichi-shi, Mie (JP)

(21) Appl. No.: 16/955,855

(22) PCT Filed: Dec. 13, 2018
(86) PCT No.: PCT/JP2018/045839

§ 371 Date: Jun. 19, 2020

(30) Foreign Application Priority Data
Dec. 20, 2017 (JP) 2017-243635

(51) Int. Cl. G01P 1/02; G01P 3/44; H01R 13/52

(52) U.S. Cl. CPC G01P 1/02; H01R 13/5205; G01P 3/44

(57) ABSTRACT

A sensor component includes a sensor a holder that holds the sensor; a cable that is to be electrically connected to the sensor, and that extends rearward from the holder. A rubber stopper is disposed rearward of the holder, and has a through hole for the cable to extend through. The through hole adheres to an outer circumferential surface of the cable, and adheres to a portion of a rear surface of the holder. The portion of the rear surface of the holder being located at a peripheral edge of the cable. A cover that engages with the holder in a state in which the cover presses the rubber stopper forward.

### CROSS-REFERENCE TO RELATED APPLICATIONS

This application is the U.S. national stage of PCT/JP2018/045839 filed on Dec. 13, 2018, which claims priority of Japanese Patent Application No. JP 2017-243635 filed on Dec. 20, 2017, the contents of which are incorporated herein.

### TECHNICAL FIELD

The present disclosure relates to a sensor component.

### BACKGROUND

Conventionally, sensor components connected to end portions of wire harnesses are known (described, for example, in JP 2017-096828A below). A sensor component includes a sensor and a holder that holds the sensor, and a cable connected to the sensor extends rearward from the holder. The holder includes an inner portion and an outer portion molded integrally with the inner portion on the outer side of the inner portion, and the outer portion is formed, for example, through injection molding so as to cover the sensor, the inner portion, and a part of the cable connected to the sensor. The sheath of the cable and the outer portion are fused to each other by the molding heat of the outer portion, thus preventing entry of water into the holder.

However, with a configuration such as the one described above, the fused state between the outer portion and the sheath depends on the molding conditions of the outer portion, the material of the sheath, and so forth. Accordingly, it is difficult to ensure stable waterproofing performance.

The present disclosure has been completed in view of the above-described circumstances, and it is an object of the disclosure to provide a sensor component that can ensure stable waterproofing performance.

### SUMMARY

A sensor component according to the present disclosure includes: a sensor; a holder that holds the sensor; a cable that is to be electrically connected to the sensor, and that extends rearward from the holder; a rubber stopper that is disposed rearward of the holder, that has a through hole for the cable to extend through, that adheres to an outer circumferential surface of the cable, and that adheres to a portion of a rear surface of the holder, the portion being located at a peripheral edge of the cable; and a cover that engages with the holder in a state in which the cover presses the rubber stopper forward.

### Advantageous Effects of Disclosure

According to the present disclosure, the rubber stopper can prevent water from entering into the holder from a peripheral edge of the cable, and it is thus possible to ensure stable waterproofing performance.

### BRIEF DESCRIPTION OF DRAWINGS

FIG. 1 is a side view showing a sensor component according to Embodiment 1.

FIG. 2 is a cross-sectional view showing the sensor component.

FIG. 3 is a perspective view showing the holder.

FIG. 4 is a side view showing the holder.

FIG. 5 is a rear view showing the holder.

FIG. 6 is a perspective view showing the rubber stopper.

FIG. 7 is a side view showing the rubber stopper.

FIG. 8 is a cross-sectional view showing the rubber stopper.

FIG. 9 is a perspective view showing the cover.

FIG. 10 is a cross-sectional view showing the cover.

FIG. 11 is a side view showing a sensor component according to Embodiment 2.

FIG. 12 is a cross-sectional view showing a part of the sensor component, the cross-sectional view corresponding to a cross section taken along the position A-A in FIG. 11.

FIG. 13 is a perspective view showing the holder.

FIG. 14 is a plan view showing the holder.

FIG. 15 is a side view showing the holder.

FIG. 16 is a rear view showing the holder.

FIG. 17 is a perspective view showing the cover.

FIG. 18 is a cross-sectional view showing the cover.

FIG. 19 is a side view showing a sensor component according to Embodiment 3.

FIG. 20 is a cross-sectional view showing a part of the sensor component.

FIG. 21 is a perspective view showing the cover.

FIG. 22 is a cross-sectional view showing the cover.

### DETAILED DESCRIPTION OF PREFERRED EMBODIMENTS

Preferred embodiments of the present disclosure will be described below.

In the sensor component according to the present disclosure, the holder may include an inner portion that holds the sensor, and an outer portion molded integrally with the inner portion on an outer side of the inner portion, and the outer portion may surround a part of the cable in a length direction of the cable, and be fused to a sheath of the cable around the entire circumference of the sheath. With this configuration, in addition to the waterproofing provided by the rubber stopper, the outer portion and the sheath are fused to each other, thus making it possible to ensure higher waterproofing performance.

In the sensor component according to the present disclosure, a cover fitting portion to which the cover can be externally fitted may be provided at a rear end portion of the holder, and a male screw portion may be formed on the cover fitting portion, and a female screw portion may be formed on the cover. With this configuration, it is possible to fix the cover to the holder by threadably engaging the cover with the cover fitting portion of the holder.

### Embodiment 1

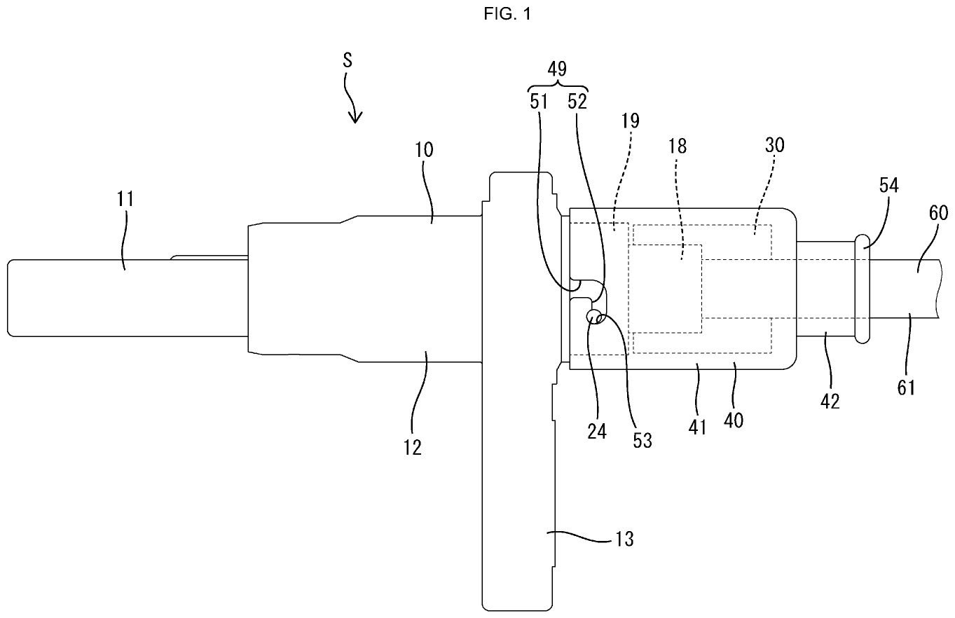

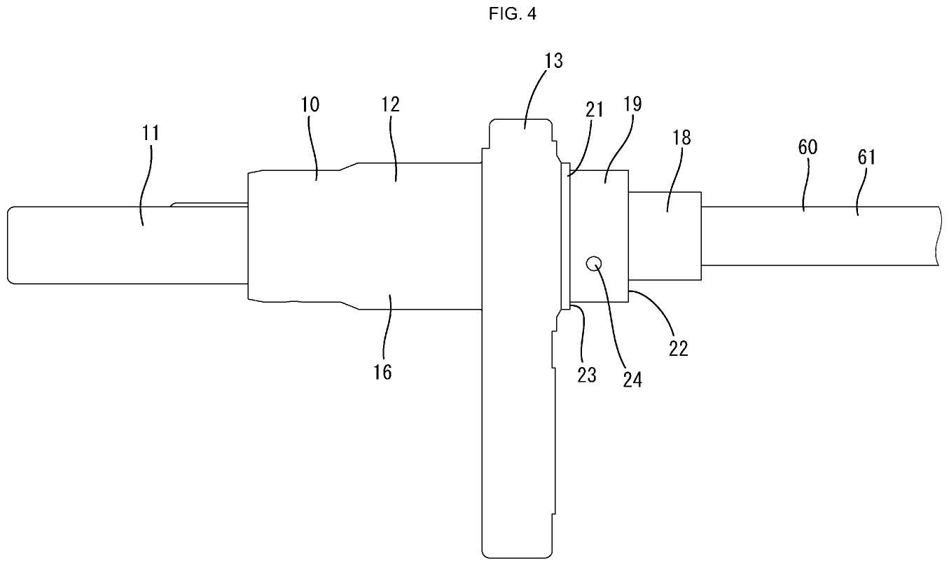

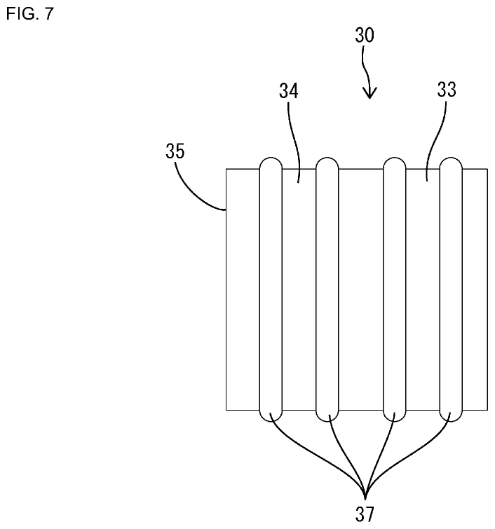

In the following, an embodiment of the present disclosure will be described in detail with reference to FIGS. 1 to 10.

A sensor component S according to the present embodiment is a vehicle sensor that is to be attached to a vehicle, in particular, a wheel speed sensor that is used to measure the wheel speed. The sensor component S is fixed to the vehicle so as to be opposed to a rotor that rotates together with a wheel of the vehicle. The sensor component S includes a cable 60 that is to be connected to a control device mounted in the vehicle. The control device of the vehicle calculates the wheel speed of the vehicle in accordance with an output signal from the sensor component S, and can be used to control an anti-lock brake system (ABS) or the like. In the following description of the constituent members, the left side in FIG. 1 is assumed to be the front side, and the right side (the extension direction of the cable 60) is assumed to be the rear side.

The sensor component S includes a sensor (not shown) including a detection element for converting a physical quantity of interest into an electrical amount or the like, a holder 10 that holds the sensor, a cable 60 that is to be electrically connected to the sensor and extends rearward from the holder 10, a rubber stopper 30 that is disposed rearward of the holder 10 and prevents water from entering into the holder 10 from the gap between the cable 60 and the holder 10, and a cover 40 that engages with the holder 10 in a state in which the cover 40 presses the rubber stopper 30 forward.

The cable 60 is formed by covering two wires (not shown) together with a sheath 61. The sheath 61 is made of urethane resin, and can be favorably fused to an outer portion 16, which will be described below. Each wire is formed by covering a conductor by an insulating covering. At an end portion of the wire, the insulating covering has been removed, and the exposed portion of the conductor is electrically connected to a connection terminal (not shown) of the sensor with solder or the like.

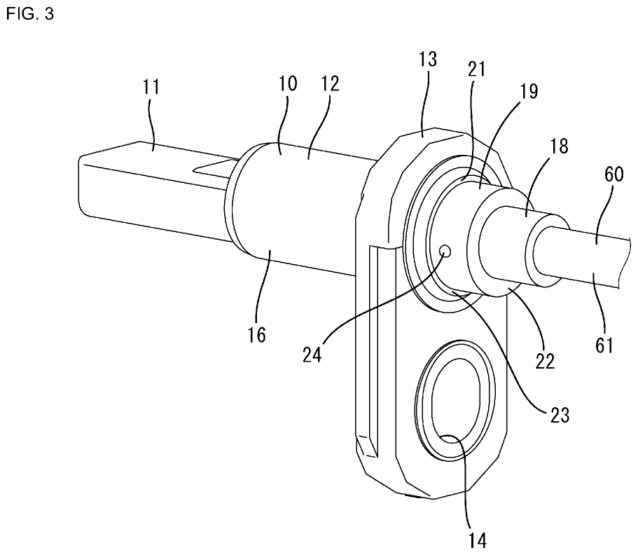

The holder 10 as a whole has a shape that is elongated in the front-rear direction thereof. As shown in FIG. 3, the portion of the holder 10 on the front side (hereinafter referred to as the “holder front portion” 11) has the shape of a quadrangular prism, and the portion thereof on the rear side (hereinafter referred to as the “holder rear portion 12”) has a columnar shape. The sensor is embedded in the holder front portion 11, and a portion of the cable 60 is embedded in the holder rear portion 12.

The holder 10 is provided with a bracket 13 that is to be fixed to the vehicle. The bracket 13 is provided at a position located toward the rear end of the holder 10. The bracket 13 has the shape of a substantially oblong plate, a fixing hole 14 for fixing the bracket 13 to the vehicle is formed in one end portion of the bracket 13 in the longitudinal direction, and an insertion hole 25 to which the holder 10 is fixed is formed in the other end portion thereof. The bracket 13 and the holder 10 are integrated with each other in the insertion hole 25.

The holder 10 includes an inner portion 15 that holds the sensor, and an outer portion 16 that seals the inner portion 15 with resin. The inner portion 15 and the outer portion 16 are made of a synthetic resin such as polyamide (PA) containing, for example, reinforced fibers such as glass fibers and carbon fibers.

The inner portion 15 is formed by performing insert molding (primary molding) using the sensor as an insert. The outer portion 16 is formed by performing insert molding (secondary molding) using, as an insert, the primary molded article in a state in which the cable 60 is connected thereto. That is, the outer portion 16 is molded integrally with the primary molded article on the outer side of the primary molded article by filling a resin material in a molten state into a mold in which the primary molded article is placed.

The outer portion 16 forms substantially the whole of the holder rear portion 12. The outer portion 16 surrounds a part of the cable 60 around the entire circumference thereof, and is thermally fused to the sheath 61 of the cable 60 around the entire circumference thereof by the heat applied when the outer portion 16 is molded, thus adhering to the sheath 61 without any gap.

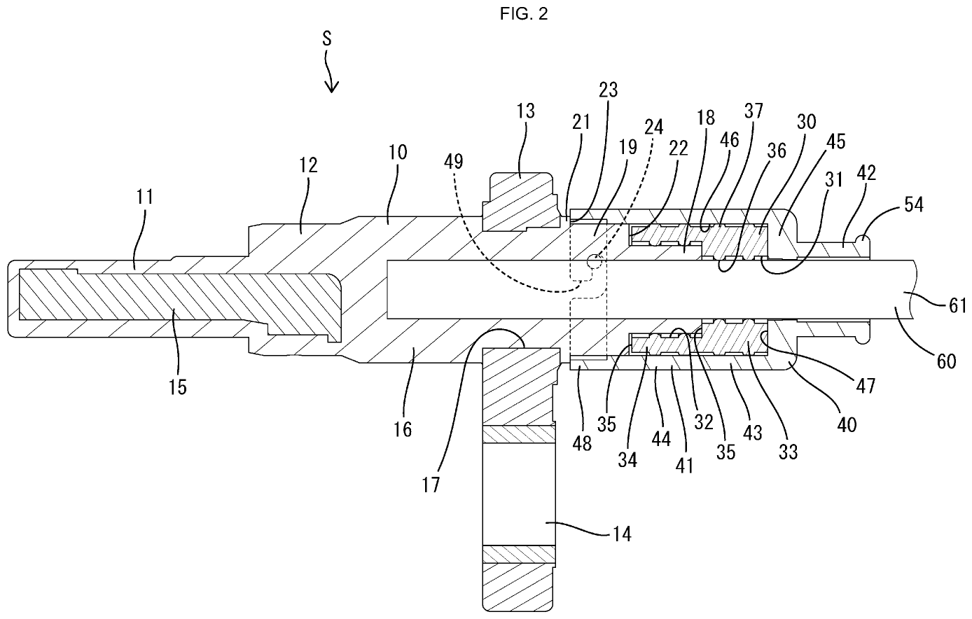

As shown in FIG. 2, a rubber stopper fitting portion 18 to which the rubber stopper 30 is fitted and a cover fitting portion 19 to which the cover 40 is fitted are provided at a rear end portion of the holder 10.

The rubber stopper fitting portion 18 has the shape of a tube and surrounds the cable 60, and is formed so as to protrude one step rearward from the rear surface of the cover fitting portion 19. The cover fitting portion 19 is provided at a portion of the holder 10 that is located forward of the rubber stopper fitting portion 18 and rearward of the bracket 13.

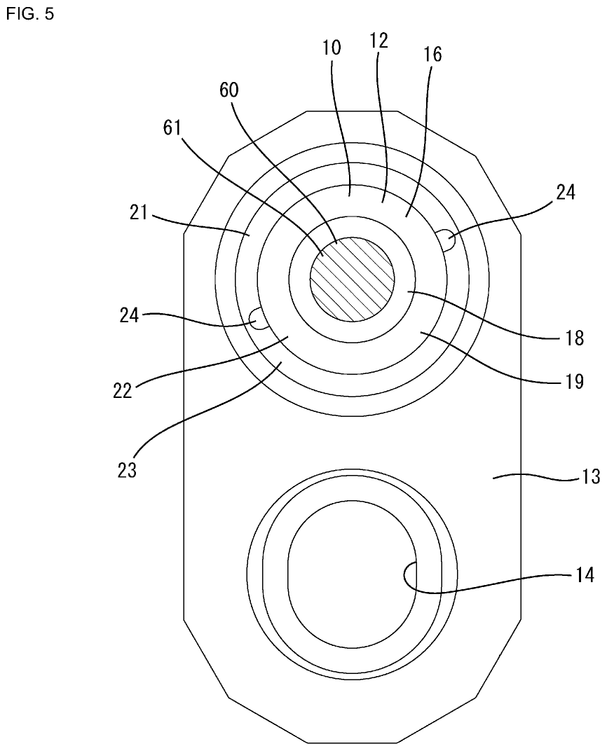

As shown in FIG. 5, the rubber stopper fitting portion 18 and the cover fitting portion 19 have annular shapes that are coaxial about the cable 60, when the holder 10 is viewed from the rear. The cover fitting portion 19 is one size larger, or in other words, has a larger thickness (radial dimension) than the rubber stopper fitting portion 18.

As shown in FIG. 2, stepped surfaces 22 and 23 intersecting (orthogonal to) the axial direction of the cable 60 are formed at the front end of the rubber stopper fitting portion 18 and the front end of the cover fitting portion 19. The first stepped surface 22 located at the front end of the rubber stopper fitting portion 18 is opposed, in the front-rear direction, to the front end face of the rubber stopper 30 in a state in which the rubber stopper 30 is fitted to the rubber stopper fitting portion 18. The second stepped surface 23 located at the front end of the cover fitting portion 19 is opposed, in the front-rear direction, to the front end face of the cover 40 in a state in the cover 40 is fitted to the cover fitting portion 19. The second stepped surface 23 has a smaller radial dimension (smaller height difference) than the first stepped surface 22. Note that the second stepped surface 23 constitutes the rear surface of a flange portion 21 provided along the rear surface of the bracket 13, and is disposed in proximity to the bracket 13.

The cover fitting portion 19 is provided with engagement receiving portions 24 with which the cover 40 engages. As shown in FIGS. 3 and 5, each engagement receiving portion 24 is a projection protruding from the outer circumferential surface of the cover fitting portion 19. A pair of engagement receiving portions 24 are provided at positions that are symmetrical with respect to the central axis of the cover fitting portion 19. Each of the engagement receiving portions 24 has the shape of a circular dome. In addition, each of the engagement receiving portions 24 is provided at a central part of the cover fitting portion 19 in the front-rear direction.

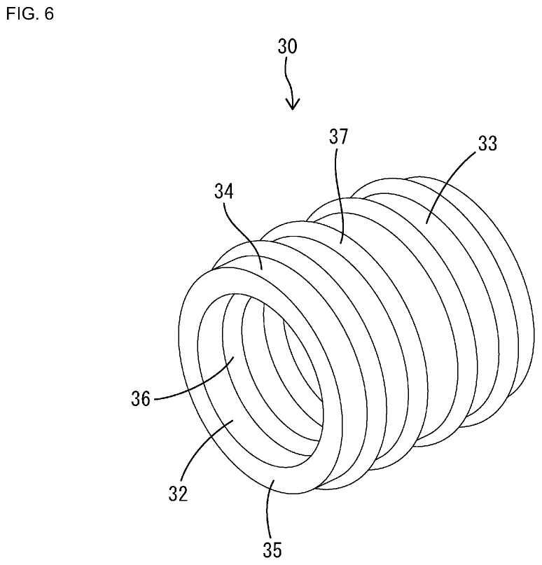

The rubber stopper 30 is made of a rubber such as silicon rubber, and has the overall shape of a substantially circular tube as shown in FIG. 6. As shown in FIG. 2, inside the rubber stopper 30, a through hole 31 adhering to the outer circumferential surface of the cable 60 and a fitting hole 32 externally fitted to the rubber stopper fitting portion 18 are formed continuously in the axial direction. The diameter of the through hole 31 is set to be smaller than the diameter of the fitting hole 32. In other words, the thickness of a portion of the rubber stopper 30 where the through hole 31 is formed (hereinafter referred to as the “cable through portion 33”) is set to be larger than the thickness of a portion where the fitting hole 32 is formed (hereinafter referred to as the “holder fitting portion 34”). The axial dimension of the holder fitting portion 34 is set to be equivalent to the axial dimension of the rubber stopper fitting portion 18.

As shown in FIG. 2, opposite surfaces 35 that are opposed to the rear surface of the holder 10 in a state in which the rubber stopper 30 is attached to the holder 10 are formed on the rubber stopper 30. Opposite surfaces 35 are provided on the front end face of the rubber stopper 30 and the inner circumferential surface of the rubber stopper 30. The opposite surfaces 35 of the rubber stopper 30 adhere to a peripheral edge portion of the rear surface of the holder 10 that surrounds the entire circumference of the cable 60 in a state in which the rubber stopper 30 is attached to the holder 10. Of the opposite surfaces 35, at least one of the opposite surface 35 located at the front end of the rubber stopper 30 and the opposite surface 35 located on the inner circumferential surface (the opposite surface 35 provided on the inner circumferential surface of the rubber stopper 30 in the present embodiment) adheres to the rear surface of the holder 10. Note that the opposite surfaces 35 are substantially orthogonal to the axial direction of the rubber stopper 30. The opposite surface 35 provided on the inner circumferential surface of the rubber stopper 30 is located between the cable through portion 33 and the holder fitting portion 34.

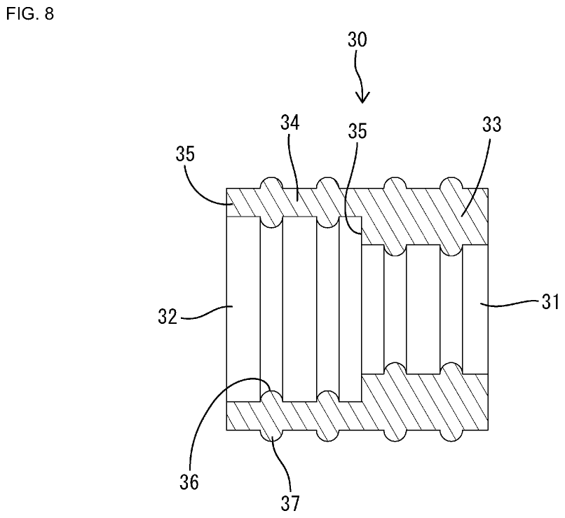

As shown in FIG. 8, inner circumferential lip portions 36 that each adhere to the cable 60 or the rubber stopper fitting portion 18 are provided on the inner circumferential surface of the through hole 31 and the inner circumferential surface of the fitting hole 32. A plurality of (two in the present embodiment) inner circumferential lip portions 36 are provided on each of the inner circumferential surface of the through hole 31 and the inner circumferential surface of the fitting hole 32. The inner diameter of the inner circumferential lip portions 36 of the through hole 31 is set to be smaller than the outer diameter of the cable 60. The inner diameter of the inner circumferential lip portions 36 of the fitting hole 32 is set to be smaller than the outer diameter of the rubber stopper fitting portion 18.

Outer circumferential lip portions 37 that adhere to the inner circumferential surface of the cover 40 are provided on the outer circumferential surface of the rubber stopper 30. A plurality of (four in the present embodiment) outer circumferential lip portions 37 having substantially the same shape are provided at substantially fixed intervals in the axial direction of the rubber stopper 30. The outer circumferential lip portions 37 elastically adhere to the inner circumferential surface of the cover 40 around the entire circumference thereof. The same number of (two in the present embodiment) outer circumferential lip portions 37 are provided for the cable through portion 33 and the holder fitting portion 34. The position of each outer circumferential lip portion 37 and the position of the corresponding inner circumferential lip portion 36 are set to be the same in the axial direction of the rubber stopper 30.

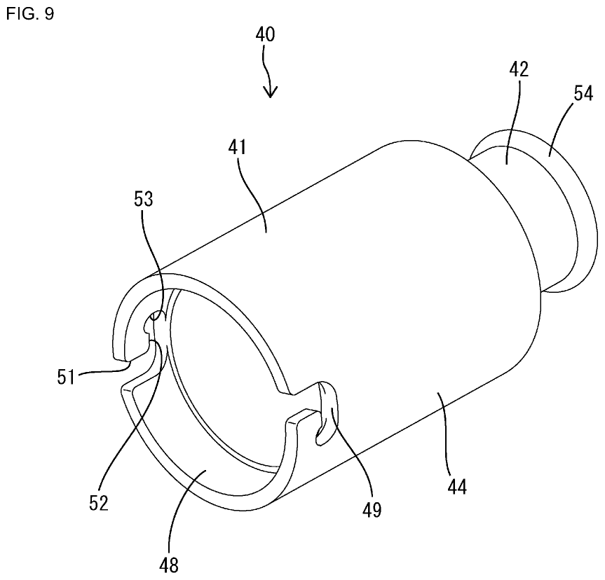

The cover 40 is made of a synthetic resin material, and has the overall shape of a substantially cross-sectionally circular tube as shown in FIG. 9. The cover 40 includes a cover body portion 41 capable of housing the rubber stopper 30 therein, and a cable leading portion 42 that is provided rearward of and continuously with the cover body portion 41 and from which the cable 60 is pulled rearward.

As shown in FIG. 2, of the cover body portion 41, a rubber stopper housing portion 43 that houses the rubber stopper 30 includes an outer wall portion 44 that covers the outer circumferential surface of the rubber stopper 30 and a rear wall portion 45 that covers the rear surface of the rubber stopper 30. The inner circumferential surface of the outer wall portion 44 serves as a sealing surface 46 to which the outer circumferential lip portions 37 of the rubber stopper 30 adhere. The front surface of the rear wall portion 45 serves as a pressing surface 47 that presses the rear surface of the rubber stopper 30 forward.

A front end portion of the cover body portion 41 serves as a front end stepped portion 48 having a larger inner diameter than the other portions. The thickness of the front end stepped portion 48 is set to be smaller than the thicknesses of the other portions. Consequently, the outer circumferential surface of the front end stepped portion 48 extends continuously with the outer circumferential surfaces of the other portions of the cover body portion 41 without any height difference.

The cover body portion 41 is provided with engaging portions 49 that engage with the holder 10. As shown in FIG. 9, each engaging portion 49 has the shape of a groove into which the engagement receiving portion 24 of the holder 10 can be placed. The engaging portion 49 has a substantially L-shaped overall shape, and the whole of the engaging portion 49 is formed in the front end stepped portion 48. The engaging portion 49 extends through the cover body portion 41 in the inward-outward direction, and is open forward at the front end of the cover body portion 41. A pair of engaging portions 49 are provided so as to correspond to the engagement receiving portions 24.

Each of the engaging portions 49 includes a receiving portion 51 extending from the front end of the cover body portion 41 in the axial direction of the cover body portion 41 and capable of receiving the corresponding engagement receiving portion 24, and an intersecting portion 52 extending from the rear end of the receiving portion 51 in the axial direction of the cover body portion 41. The receiving portion 51 and the intersecting portion 52 are substantially orthogonal to each other. At the pair of engaging portions 49, the intersecting portions 52 extend from the rear ends of the respective corresponding receiving portions 51 in the same direction in the circumferential direction of the cover body portion 41.

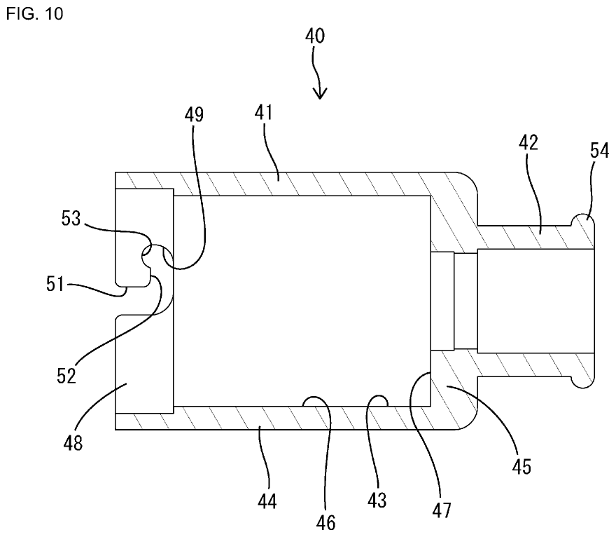

The protruding end of each intersecting portion 52 is closed, and serves as a lock portion 53 that is fitted to the corresponding engagement receiving portion 24 so as to lock the engagement receiving portion 24. As shown in FIG. 10, the lock portion 53 has a shape in conformity with the outer shape of the engagement receiving portion 24 so as to expand one step forward at the protruding end of the intersecting portion 52. The engagement receiving portion 24 that has been fitted to the lock portion 53 is restricted from moving back to the receiving portion 51 side.

As shown in FIG. 10, the cable leading portion 42 protrudes from the rear wall portion 45 of the cover body portion 41 along the axial direction of the cover body portion 41. A rib 54 protruding outward from the rear edge of the cable leading portion 42 continuously around the entire circumference is provided. The cable leading portion 42 has the shape of a tube and extends along the outer circumferential surface of the cable 60.

Next, an example of the operation of attaching the rubber stopper 30 and the cover 40 in the sensor component S according to the present embodiment will be described.

First, the rubber stopper 30 is attached to the holder 10. The rubber stopper 30 in a state in which the cable 60 extends therethrough is brought close to the holder 10 from behind, and the holder fitting portion 34 of the rubber stopper 30 is attached so as to cover the rubber stopper fitting portion 18 of the holder 10. In a state in which the rubber stopper 30 is attached so as to cover the holder 10, the opposite surface 35 of the rubber stopper 30 is disposed so as to be opposed to the rear surface of the holder 10, and the inner circumferential lip portions 36 of the rubber stopper 30 adhere to each of the outer circumferential surface of the holder 10 and the outer circumferential surface of the cable 60.

Next, the cover 40 is attached to the holder 10. The cover body portion 41 is externally fitted to the rubber stopper 30, and the cover 40 is pushed forward such that the engagement receiving portions 24 of the holder 10 are placed into the engaging portions 49. The engagement receiving portions 24 are placed into the receiving portions 51 of the engaging portions 49, and eventually reach the rear ends thereof. Then, when the cover 40 is rotated, the engagement receiving portions 24 are placed into the intersecting portions 52. At this time, the rubber stopper 30 is elastically contracted by being pressed forward by the cover 40. By releasing the hand from the cover 40 when the engagement receiving portions 24 have reached the lock portions 53 after passing through the intersecting portions 52, the rubber stopper 30 is elastically restored, and the cover 40 is relatively displaced rearward, resulting in a state in which the lock portions 53 are fitted to the engagement receiving portions 24. Thus, the engagement receiving portions 24 are brought into a locked state as a result of being locked to the lock portions 53, whereby the cover 40 is prevented from falling off.

As a result of the foregoing, the operation of attaching the rubber stopper 30 and the cover 40 is completed.

As shown in FIG. 2, in a state in which the rubber stopper 30 and the cover 40 are attached to the holder 10, the front end of the cover 40 is in proximity to or abutment against the second stepped surface 23, and the cover 40 lies over the entirety of the cover fitting portion 19. In addition, as a result of the rear wall portion 45 of the cover 40 pressing the rubber stopper 30 forward, the opposite surface 35 of the rubber stopper 30 is brought into a state in which it elastically adheres to the rear surface of the holder 10. Furthermore, the outer circumferential lip portions 37 of the rubber stopper 30 elastically adhere to the cover 40, and the inner circumferential lip portions 36 elastically adhere to the holder 10 and the cable 60.

Next, the operation and effects of the embodiment configured in the above-described manner will be described.

The sensor component S according to the present embodiment includes a sensor; a holder 10 that holds the sensor; a cable 60 that is to be electrically connected to the sensor, and that extends rearward from the holder 10; a rubber stopper 30 that is disposed rearward of the holder 10, that has a through hole 31 for the cable 60 to extend through, that adheres to an outer circumferential surface of the cable 60, and that adheres to a portion of a rear surface of the holder 10, the portion being located at a peripheral edge of the cable 60; and a cover 40 that engages with the holder 10 in a state in which the cover 40 presses the rubber stopper 30 forward. With this configuration, the rubber stopper 30 can prevent water from entering into the holder 10 from the peripheral edge of the cable 60, and it is therefore possible to ensure stable waterproofing performance. That is, stable waterproofing performance can be ensured regardless of the fused state between the cable 60 and the outer portion 16, and it is therefore possible to select the materials of the sheath 61 of the cable 60 and the outer portion 16, without taking the fusion properties between the sheath 61 and the outer portion 16 into consideration. Accordingly, for example, the sheath 61 is not limited to a sheath made of urethane resin, and may be made of another material such as vinyl chloride resin.

The holder 10 includes the inner portion 15 that holds the sensor and the outer portion 16 molded integrally with the inner portion 15 on the outer side of the inner portion 15, and the outer portion 16 surrounds a part of the cable 60 in the length direction of the cable 60, and is fused to the sheath 61 of the cable 60 around the entire circumference of the sheath 61. With this configuration, in addition to the waterproofing provided by the rubber stopper 30, the outer portion 16 and the sheath 61 are fused to each other, thus making it possible to ensure higher waterproofing performance.

### Embodiment 2

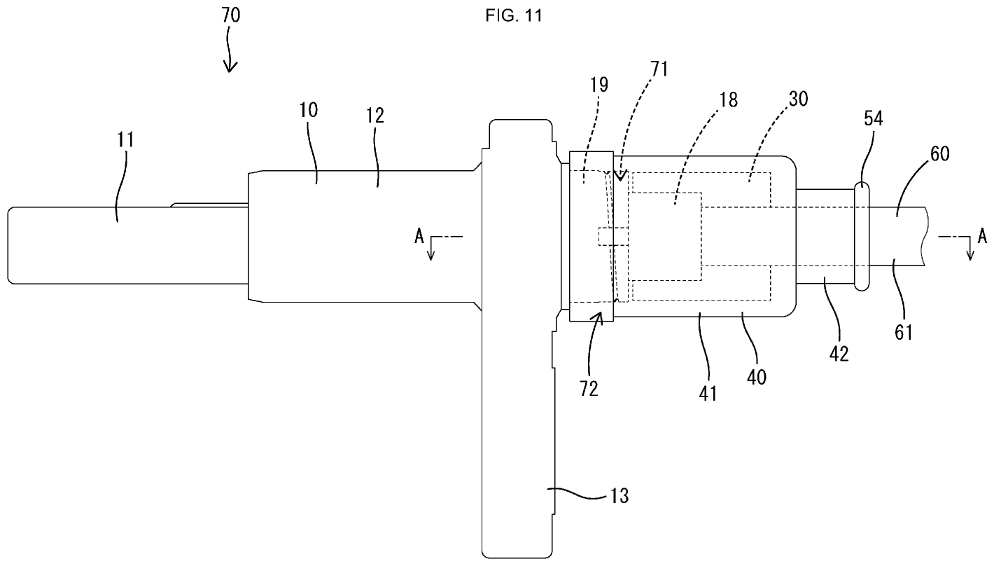

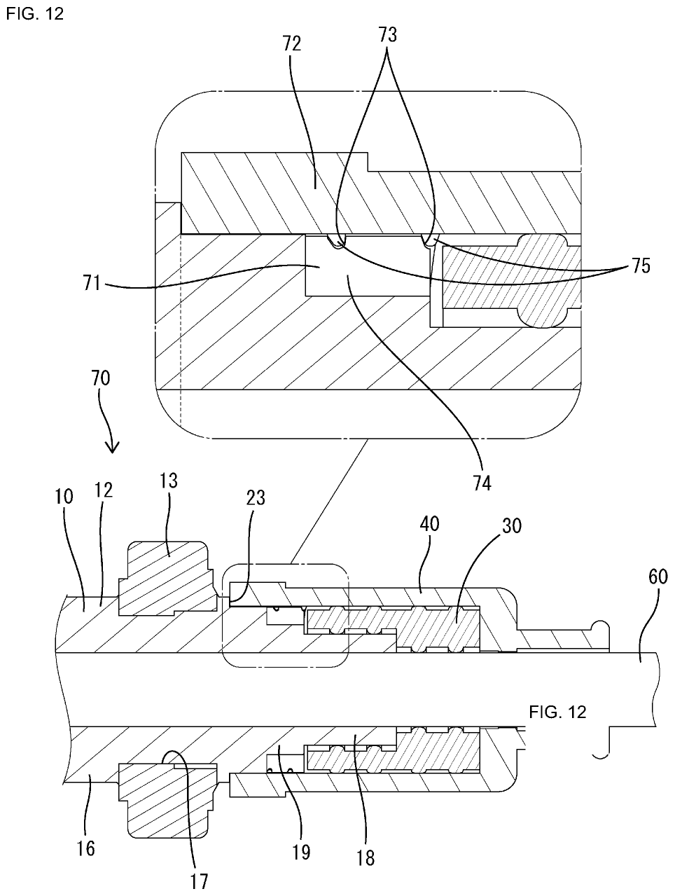

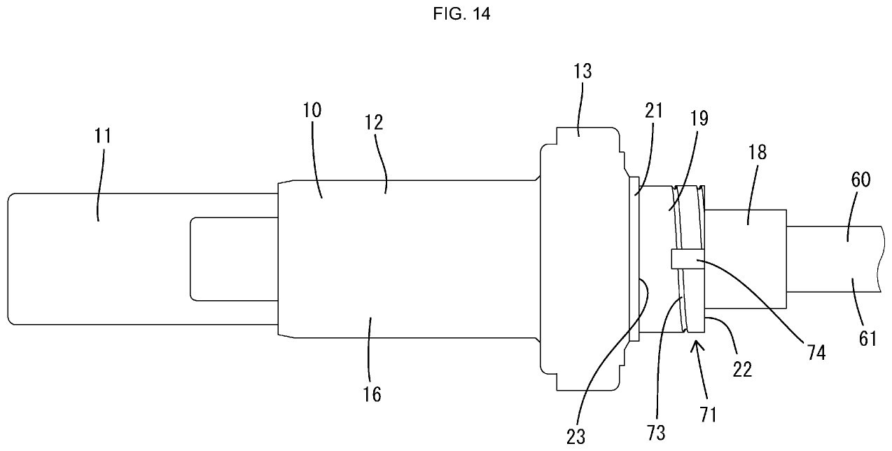

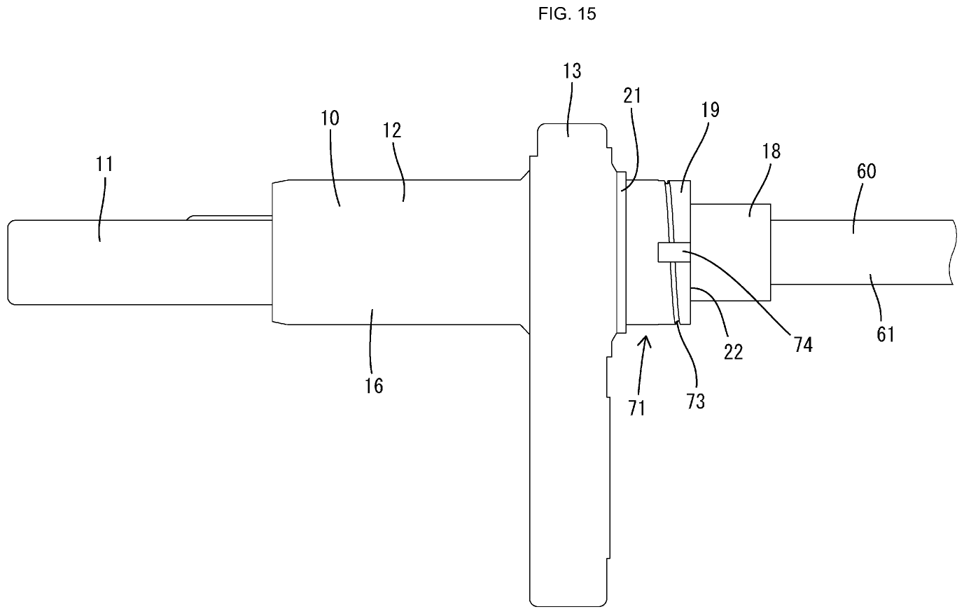

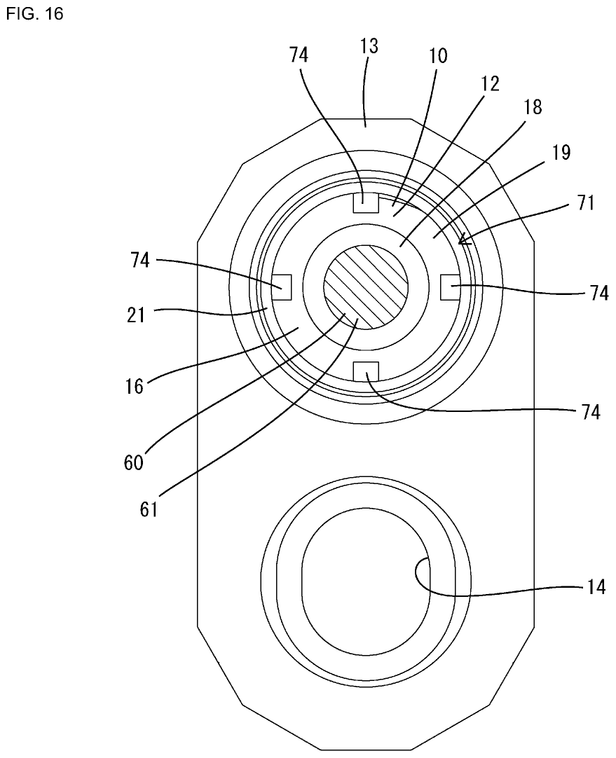

Next, a sensor component 70 according to Embodiment 2 of the present disclosure will be described with reference to FIGS. 11 to 18.

The sensor component 70 of the present embodiment is different from Embodiment 1 in that the engagement structure between the holder 10 and the cover 40 is a threadable engagement structure between a male screw portion 71 and a female screw portion 72. Note that the same constituent elements as those of Embodiment 1 are denoted by the same reference numerals, and redundant descriptions thereof have been omitted.

As in the case of Embodiment 1, the sensor component 70 according to the present embodiment includes a sensor, a holder 10 that holds the sensor, a cable 60 extending rearward from the holder 10, a rubber stopper 30 disposed rearward of the holder 10, and a cover 40 that presses the rubber stopper 30 forward. In addition, the holder 10 includes an inner portion 15 that holds the sensor, and an outer portion 16 molded integrally with the inner portion 15 on the outer side of the inner portion 15, and the outer portion 16 is thermally fused to a sheath 61 of the cable 60.

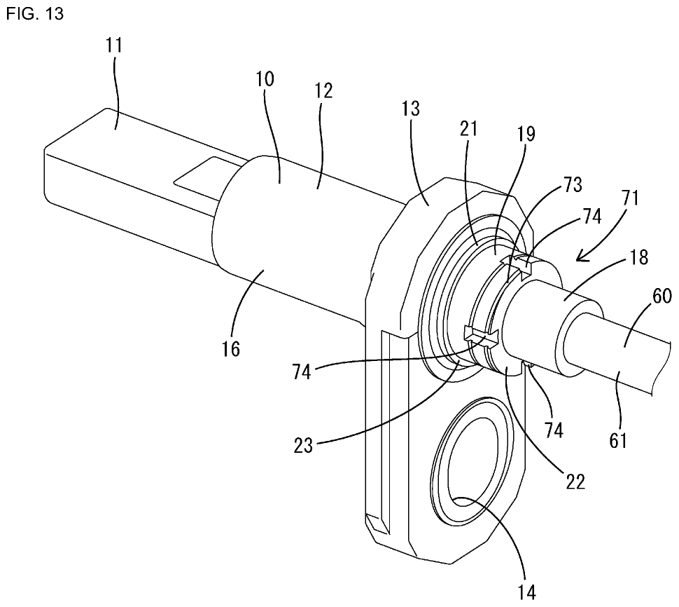

As shown in FIG. 13, the male screw portion 71 is formed on the outer circumferential surface of a rear end portion of the holder 10. As in the case of Embodiment 1, a rubber stopper fitting portion 18 and a cover fitting portion 19 are provided at the rear end portion of the holder 10, and the male screw portion 71 is formed on the outer circumferential surface of the cover fitting portion 19.

The male screw portion 71 is provided at a substantially rear half portion of the cover fitting portion 19. The male screw portion 71 has a threaded groove 73 formed therein for one and a half rounds around the cover fitting portion 19 from the upper end (the end opposite to the fixing hole 14 in FIG. 13) of the rear end of the cover fitting portion 19 in the circumferential direction. The threaded groove 73 is formed so as to spirally extend gradually forward from the rear end of the cover fitting portion 19.

Recesses 74 are formed in the male screw portion 71 so as to divide the threaded groove 73. A plurality of (four in the present embodiment) recesses 74 are provided at positions at which the cover fitting portion 19 is divided into equal parts in the circumferential direction. Each recess 74 has the shape of a groove that is slightly elongated in the front-rear direction at a substantially rear half portion of the cover fitting portion 19, and the rear end of the recess 74 is open.

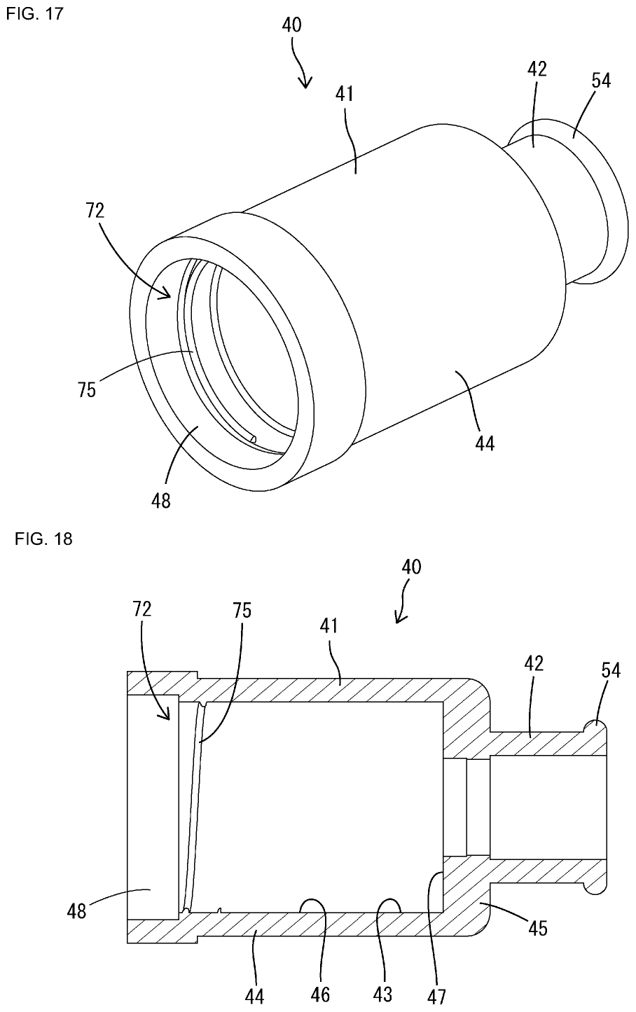

As shown in FIG. 17, the female screw portion 72 is formed on the inner circumferential surface of a front end portion of the cover 40. As in the case of Embodiment 1, a front end portion of a cover body portion 41 of the cover 40 serves as a front end stepped portion 48 having a larger inner diameter than the other portions, and the female screw portion 72 is provided on the rear side of the front end stepped portion 48.

The female screw portion 72 has a thread 75 formed thereon for about one and a half rounds around the cover body portion 41 from a position on the rear side of the front end stepped portion 48. The thread 75 is formed so as to spirally extend gradually rearward from the rear side of the front end stepped portion 48. Note that the front end stepped portion 48 of the present embodiment has a thickness equivalent to the thicknesses of the other portions, and the outer circumferential surface of the front end stepped portion 48 protrudes one step outward relative to the outer circumferential surfaces of the other portions of the cover body portion 41.

As in the case of Embodiment 1, in order to attach the cover 40 in the sensor component 70 of the present embodiment, after the rubber stopper 30 has been attached to the holder 10, the cover body portion 41 is attached so as to cover the rubber stopper 30, the front end portion of the cover 40 is externally fitted to the cover fitting portion 19, and the cover 40 is rotated to threadably engage the male screw portion 71 and the female screw portion 72 with each other. With the rotation of the cover 40, the cover 40 moves forward while its force pressing the rubber stopper 30 forward is being increased. When the front end of the cover 40 is in proximity to or abutment against the second stepped surface 23, and the cover 40 lies over the entirety of the cover fitting portion 19, the operation of attaching the rubber stopper 30 and the cover 40 is completed.

As in the case of Embodiment 1, in a state in which the rubber stopper and the cover 40 are attached to the holder 10, the opposite surface 35 of the rubber stopper 30 elastically adheres to the rear surface of the holder 10 as a result of the rear wall portion 45 of the cover 40 pressing the rubber stopper 30 forward. Furthermore, the outer circumferential lip portions 37 of the rubber stopper 30 elastically adhere to the cover 40, and the inner circumferential lip portions 36 elastically adhere to the holder 10 and the cable 60.

As described above, in the present embodiment, as in the case of Embodiment 1, the rubber stopper 30 can prevent water from entering into the holder 10 from the peripheral edge of the cable 60, and it is therefore possible to ensure stable waterproofing performance. Also, in addition to the waterproofing provided by the rubber stopper 30, the outer portion 16 and the sheath 61 are fused to each other, thus making it possible to ensure higher waterproofing performance. Furthermore, since the male screw portion 71 is formed on the holder 10, and the female screw portion 72 is formed on the cover 40, the cover 40 can be fixed to the holder 10 by threadably engaging the cover 40 with the rear end portion of the holder 10.

### Embodiment 3

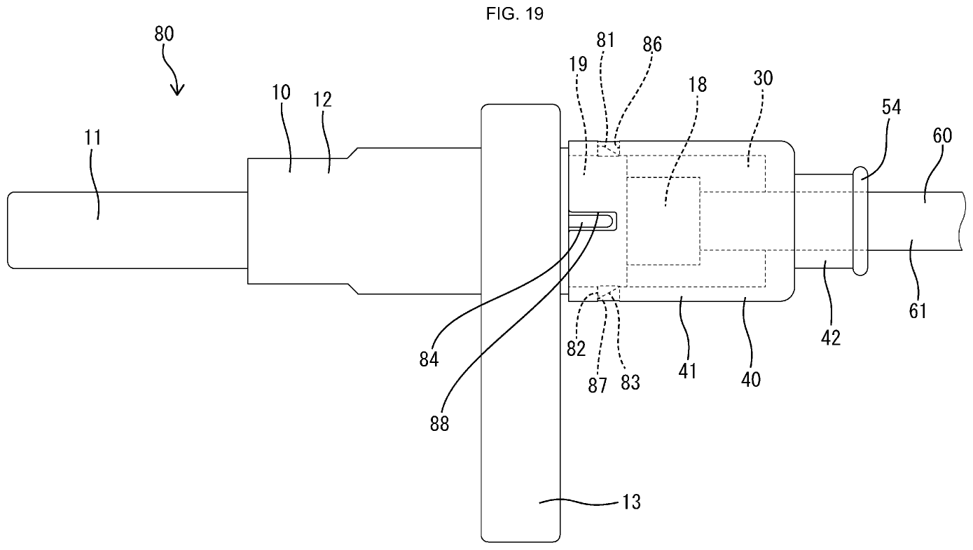

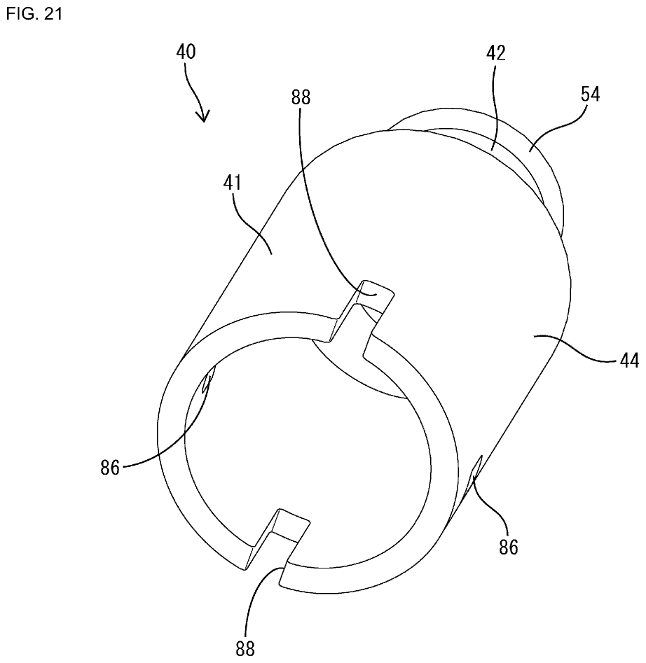

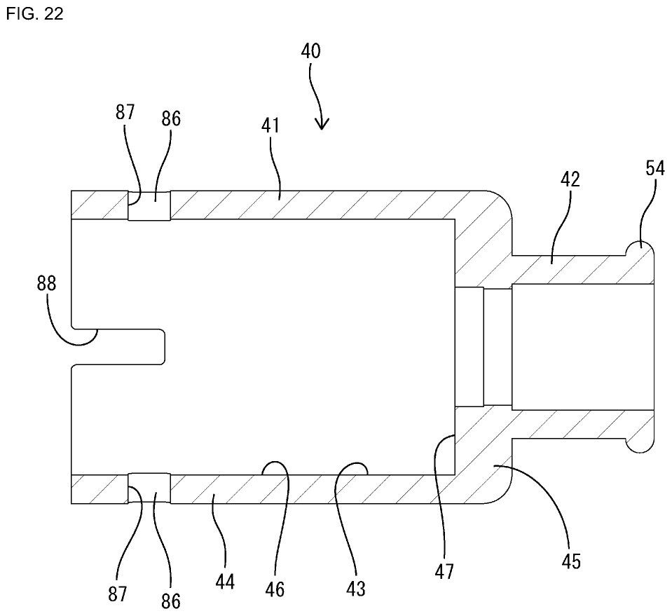

Next, a sensor component 80 according to Embodiment 3 of the present disclosure will be described with reference to FIGS. 19 to 22.

The sensor component 80 of the present embodiment is different from Embodiment 1 with regard to the engagement structure between the holder 10 and the cover 40. Note that the same constituent elements as those of Embodiment 1 are denoted by the same reference numerals, and redundant descriptions thereof have been omitted.

As in the case of Embodiment 1, the sensor component 80 according to the present embodiment includes a sensor, a holder 10 that holds the sensor, a cable 60 extending rearward from the holder 10, a rubber stopper 30 disposed rearward of the holder 10, and a cover 40 that presses the rubber stopper 30 forward. In addition, the holder 10 includes an inner portion 15 that holds the sensor, and an outer portion 16 molded integrally with the inner portion 15 on the outer side of the inner portion 15, and the outer portion 16 is thermally fused to a sheath 61 of the cable 60.

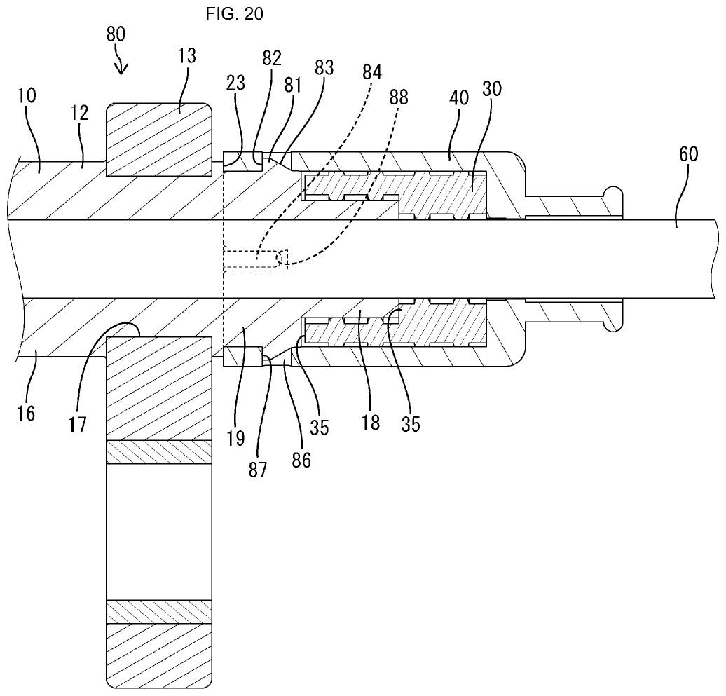

As in the case of Embodiment 1, a rubber stopper fitting portion 18 and a cover fitting portion 19 are provided at a rear end portion of the holder 10. As in the case of Embodiment 1, the cover 40 includes a cover body portion 41 capable of housing the rubber stopper 30 therein, and a cable leading portion 42 that is provided rearward of and continuously with the cover body portion 41 and from which the cable 60 is pulled rearward. Note that, unlike Embodiment 1, the front end portion of the cover body portion 41 has an inner diameter equal to the inner diameters of the other portions, and a thickness equivalent to the thicknesses of the other portions (see FIG. 20).

The cover fitting portion 19 is provided with engagement receiving portions 81 with which the cover 40 engages. As shown in FIGS. 19 and 20, each engagement receiving portion 81 is a projection protruding from the outer circumferential surface of the cover fitting portion 19. A pair of engagement receiving portions 81 are provided at positions that are symmetrical with respect to the central axis of the cover fitting portion 19. Each of the engagement receiving portions 81 has an engaged surface 82 that is substantially orthogonal to the central axis of the cover fitting portion 19, and an engagement guiding surface 83 that is inclined such that the protruding dimension thereof is gradually increased toward the front. Each engagement receiving portion 81 is provided at a position of the cover fitting portion 19 that is located toward the rear end in the front-rear direction.

The cover fitting portion 19 is provided with guide portions 84 that guide the forward movement of the cover 40 when mounting the cover 40 (see FIG. 19). Each guide portion 84 is a rib-shaped projection elongated in the front-rear direction and protruding from the outer circumferential surface of the cover fitting portion 19. A pair of guide portions 84 are provided at positions that are symmetrical with respect to the central axis of the cover fitting portion 19. Each guide portion 84 has a pair of side surfaces extending in the front-rear direction and being substantially parallel to each other. A rear end portion of each of the guide portions 84 reaches a substantially equal position as the engagement receiving portions 81 in the front-rear direction. Note that the engagement receiving portions 81 and the guide portions 84 are disposed at positions at which the outer circumferential surface of the cover fitting portion 19 is divided into equal parts in the circumferential direction.

The cover body portion 41 is provided with engaging portions 86 that engage with the holder 10. As shown in FIGS. 19 and 20, each engaging portion 86 has the shape of a hole into which the corresponding engagement receiving portion 81 of the holder 10 can be placed. Each engaging portion 86 is a substantially rectangular hole that is closed around the entire circumference thereof, and extends through the cover body portion 41 in the inward-outward direction. A pair of engaging portions 86 are provided so as to correspond to the engagement receiving portions 81.

Each engaging portion 86 has an engaging surface 87 that engages with the engaged surface 82 of the corresponding engagement receiving portion 81. The engaging surface 87 constitutes the front surface of the engaging portion 86, and is substantially orthogonal to the axis of the cover body portion 41. In a state in which the engagement receiving portion 81 and the engaging portion 86 are fitted to each other, the engaged surface 82 and the engaging surface 87 are disposed so as to be opposed to each other in the front-rear direction.

The cover body portion 41 is provided with receiving portions 88 extending from the front end of the cover body portion 41 to the rear side in the axial direction of the cover body portion 41, and capable of receiving the guide portions 84 (see FIG. 19). Each receiving portion 88 has the shape of a groove that is elongated in the front-rear direction and into which the corresponding guide portion 84 can be placed from the front. Each guide portion 84 has a front end that is open forward, and extends through the cover body portion 41 in the inward-outward direction. The receiving portion 88 has a pair of side surfaces extending in the front-rear direction and being substantially parallel. As a result of the side surfaces of the receiving portion 88 and the side surfaces of the corresponding guide portion 84 coming into contact with each other, the forward movement of the cover body portion 41 is linearly guided. Note that a rear end portion of the receiving portion 88 is closed.

As in the case of Embodiment 1, in order to attach the cover 40 to the holder 10 in the sensor component 80 of the present embodiment, after the rubber stopper 30 has been attached to the holder 10, the cover body portion 41 is attached so as to cover the rubber stopper 30, and the front end portion of the cover 40 is externally fitted to the cover fitting portion 19. At this time, the cover 40 is pushed forward such that the guide portions 84 are placed into the receiving portions 88. The cover 40 is linearly moved forward by the receiving portions 88 and the guide portions 84. The front end portion of the cover body portion 41 is gradually elastically deformed outward by the inclination of the engagement guiding surfaces 83 of the engagement receiving portions 81, and is elastically restored inward when the engaging portions 86 reach the positions of the engagement receiving portions 81. The engaging portions 86 and the engagement receiving portions 81 are fitted to each other, and the engaging surfaces 87 and the engaged surfaces 82 are brought into a locked state by being engaged with each other, thus preventing the cover 40 from falling off.

As a result of the foregoing, the operation of attaching the cover 40 is completed.

As in the case of Embodiment 1, in a state in which the rubber stopper 30 and the cover 40 are attached to the holder 10, the opposite surface 35 of the rubber stopper 30 elastically adheres to the rear surface of the holder 10 as a result of the rear wall portion 45 of the cover 40 pressing the rubber stopper 30 forward. Furthermore, the outer circumferential lip portions 37 of the rubber stopper 30 elastically adhere to the cover 40, and the inner circumferential lip portions 36 elastically adhere to the holder 10 and the cable 60.

As described above, in the present embodiment, as in the case of Embodiment 1, the rubber stopper 30 can prevent water from entering into the holder 10 from the peripheral edge of the cable 60, and it is therefore possible to ensure stable waterproofing performance. Also, in addition to the waterproofing provided by the rubber stopper 30, the outer portion 16 and the sheath 61 are fused to each other, thus making it possible to ensure higher waterproofing performance.

### OTHER EMBODIMENTS

The present disclosure is not limited to the embodiments described by the above statements and drawings, and, for example, the following embodiments also fall within the technical scope of the present disclosure.

In the above-described embodiments, as an example of the operation of attaching the rubber stopper 30 and the cover 40, after the rubber stopper 30 has been attached to the holder 10, the cover 40 is attached to the holder 10. However, the present disclosure is not limited thereto. After the rubber stopper has been housed in the cover, the cover in a state in which the rubber stopper is housed therein may be attached to the holder.

In the above-described embodiments, the holder 10 includes the inner portion 15, and the outer portion 16 molded integrally with the inner portion 15 on the outer side of the inner portion 15. However, the present disclosure is not limited thereto. The holder may be manufactured in any manner as long as the holder holds the sensor.

In the above-described embodiments, the rubber stopper 30 includes the holder fitting portion 34, the rubber stopper may not necessarily include the holder fitting portion.

In the above-described embodiments, the cover 40 has a substantially tubular shape. However, the present disclosure is not limited thereto, and the cover may have any shape as long as the cover engages with the holder in a state in which the cover presses the rubber stopper forward.

Although the above-described embodiments specifically illustrate the engagement structure between the cover 40 and the holder 10, the engagement structure between the cover and the holder can be freely changed.

In Embodiment 2 above, the threaded groove 73 is formed in the male screw portion 71, and the thread 75 is formed on the female screw portion 72. However, conversely, the thread may be formed on the male screw portion, and the threaded groove may be formed in the female screw portion.

1. A sensor component comprising:
a sensor;
a holder that holds the sensor;
a cable that is to be electrically connected to the sensor, and that extends rearward from the holder;
a rubber stopper that is disposed rearward of the holder, that has a through hole for the cable to extend through, that adheres to an outer circumferential surface of the cable, and that adheres to a portion of a rear surface of the holder, the portion being located at a peripheral edge of the cable, and
a cover that engages with the holder in a state in which the cover presses the rubber stopper forward.

2. The sensor component according to claim 1,
wherein the holder includes an inner portion that holds the sensor, and an outer portion molded integrally with the inner portion on an outer side of the inner portion, and
the outer portion surrounds a part of the cable in a length direction of the cable, and is fused to a sheath of the cable around the entire circumference of the sheath.

3. The sensor component according to claim 1,
wherein a cover fitting portion to which the cover can be externally fitted is provided at a rear end portion of the holder, and
a male screw portion is formed on the cover fitting portion, and a female screw portion is formed on the cover.

4. The sensor component according to claim 2,
wherein a cover fitting portion to which the cover can be externally fitted is provided at a rear end portion of the holder, and
a male screw portion is formed on the cover fitting portion, and a female screw portion is formed on the cover.
